(19) United States
(12) Patent Application Publication
(10) Pub. No.: US 2007/0073836 A1
(43) Pub. Date: Mar. 29, 2007

(54) Sensor node assistant apparatus, sensor node integrated development apparatus, and sensor network development system using the same

(76) Inventors: Yong Hoon Choi, Yongin-si (KR); Chae Deok Lim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/435,647

(22) Filed: May 17, 2006

(30) Foreign Application Priority Data
Sep. 27, 2005 (KR) 10-2005-0089729

(51) Int. Cl. G06F 15/16

(52) U.S. Cl. 709/217

(57) ABSTRACT

Provided are a sensor node assistant apparatus, a sensor node integrated development apparatus, and a sensor network development system using the same. The sensor network development system includes a sensor node assistant apparatus disposed in at least one sensor node and communicating with a host computer, processing instructions generated from the host computer, and communicating with the sensor nodes; and a sensor node integrated development apparatus disposed in the host computer and communicating with the sensor node assistant apparatus to control the sensor nodes. Thus, it is possible to develop a more reliable sensor network system with reduced time and cost.

### CROSS-REFERENCE TO RELATED APPLICATION

This application claims priority to and the benefit of Korean Patent Application No. 2005-89729, filed on Sep. 27, 2005, the disclosure of which is incorporated herein by reference in its entirety.

### BACKGROUND

1. Field of the Invention

The present invention relates to a sensor node assistant apparatus, a sensor node integrated development apparatus, and a sensor network development system using the same, and more particularly, to a sensor node assistant apparatus, a sensor node integrated development apparatus, and a sensor network development system using the same, whereby a sensor network system with increased reliability can be developed with reduced time and cost.

2. Discussion of Related Art

Generally, in developing a sensor network system having a number of distributed sensor nodes, a host computer develops software to be installed at the sensor nodes and transmits it to each targeted sensor node through wired communication. In this manner, the software is distributed, installed, and executed.

Such a conventional technique is burdened by the difficulty of having to connect all the sensor nodes adjacent to a host computer through a cable when the developed target software is installed in the sensor nodes. In addition, since the developed target software can be only transmitted to and installed in one sensor node at a time, installing the program in a large number of sensor nodes consumes much time.

Further, there is no way to monitor operation states of the sensor nodes at remote locations until a wireless communication function of the software installed in the sensor nodes is activated. Furthermore, it may be difficult to exactly recognize the operation states of the sensor nodes due to a topology or routing problem in the sensor network even though the wireless communication function of the sensor nodes is activated.

In particular, when a defect is found in the software of the sensor nodes so that the software has to be re-installed, all sensor nodes at remote positions have to be relocated adjacent to a host system for development, and the software has to be re-installed individually in each sensor node through wired communication.

### SUMMARY OF THE INVENTION

The present invention is directed to a sensor node assistant apparatus, a sensor node integrated development apparatus, and a sensor network development system using the same, which can effectively solves the above problems by placing, in all or some of the sensor nodes, a sensor node remote development assistant apparatus for wirelessly communicating with a host computer, processing instructions from the host computer, performing wired communication with target sensor nodes, and monitoring target sensor nodes, and by placing, in the host computer, a sensor node remote integrated development apparatus interacting with sensor node remote development assistant apparatuses.

One aspect of the present invention provides a sensor node assistant apparatus comprising: sensor node communication means for performing wired communication with at least one sensor node; host instruction processing means for processing an instruction received from a host computer; and host communication means for performing wireless communication with the host computer.

Another aspect of the present invention provides a sensor node integrated development apparatus comprising: communication means for remote control and data communication with at least one sensor node; compiling means for compiling target software to be installed in the at least one sensor node and transmitting the compiled target software to the communication means; test/debugging means for testing/debugging the target software installed in the at least one sensor node by providing a testing/debugging instruction and a list of the at least one sensor node to be tested/debugged to the communication means; monitoring means for monitoring the target software installed in the at least one sensor node by providing a monitoring instruction and a list of the at least one sensor node to be monitored to the communication means; analysis/verification means for analyzing the target software and verifying system attributes by providing an analysis/verification instruction and a list of the at least one sensor node to be analyzed to the communication means; and managing means for managing the communication means, the compiling means, the test/debugging means, the monitoring means, and the analysis/verification means.

Yet another aspect of the present invention provides a sensor network development system comprising: a sensor node assistant apparatus disposed in at least one sensor node for communicating with a host computer, processing an instruction generated from the host computer, and communicating with the at least one sensor node; and a sensor node integrated development apparatus disposed in the host computer for communicating with the sensor node assistant apparatus to control the at least one sensor node.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram illustrating a sensor network development system according to an exemplary embodiment of the present invention;

FIG. 2 is a block diagram illustrating a sensor node assistant apparatus according to an exemplary embodiment of the present invention;

FIG. 3 is a block diagram illustrating a sensor node integrated development apparatus according to an exemplary embodiment of the present invention; and

FIG. 4 is a flowchart illustrating a method for implementing a sensor network development system according to an exemplary embodiment of the present invention.

### DETAILED DESCRIPTION OF EXEMPLARY EMBODIMENTS

Hereinafter, an exemplary embodiment of the present invention will be described in detail. However, the present invention is not limited to the exemplary embodiment disclosed below, but can take on various modified forms. Therefore, the present exemplary embodiment is provided for a complete disclosure of the present invention which is fully enabling to those of ordinary skill in the art.

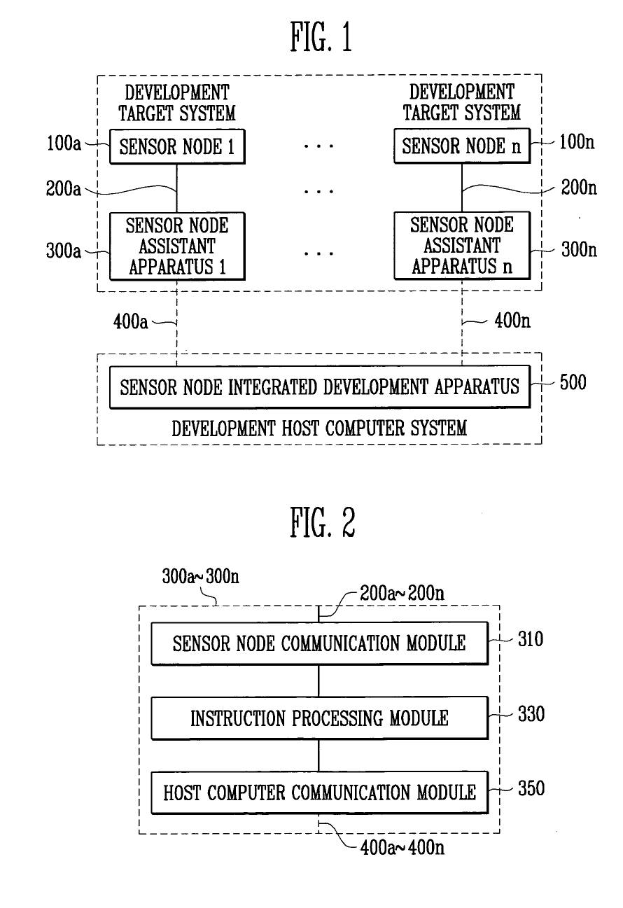

FIG. 1 is a block diagram illustrating a sensor network development system according to an exemplary embodiment of the present invention.

Referring to FIG. 1, the sensor network development system according to an exemplary embodiment of the present invention includes development target systems and a development host computer system.

Each of the development target systems includes at least one sensor node 100a to 100n and wireless sensor node development assistant apparatuses 300a to 300n (hereinafter, “sensor node assistant apparatus”) connected to the sensor nodes 100a to 100n and communicating with the sensor nodes 100a to 100n, for example, through cables 200a to 200n.

The development host computer system has a host computer including a multiple sensor node remote integrated development tool 500 (hereinafter, referred to as “sensor node integrated development apparatus”) that communicates with the sensor node assistant apparatuses 300a to 300n, for example, wirelessly, as indicated by reference numerals 400a to 400n.

FIG. 2 is a block diagram illustrating a sensor node assistant apparatus according to an exemplary embodiment of the present invention.

Referring to FIG. 2, each of the sensor node assistant apparatuses 300a to 300n according to an exemplary embodiment of the present invention includes a sensor node communication module 310, an instruction-processing module 330, and a host computer communication module 350.

The sensor node communication module 310 communicates with at least one of the sensor nodes 100a to 100n (See FIG. 1). The sensor node communication module 310 receives a target software to be installed in the sensor nodes 100a to 100n from the instruction-processing module 330 and transmits it to the sensor nodes 100a to 100n, for example, through wired communication; or receives state information from the sensor nodes 100a to 100n, for example, through the wired communication and forward it to the instruction-processing module 330.

The instruction-processing module 330 processes various instructions, which are received from a host computer. The instruction-processing module 330 receives various instructions from the host computer communication module 350 and executes them. Further, it delivers the execution results or state information of the sensor nodes 100a to 100n, which have been received from the sensor node communication module 310, to the host computer communication module 350, or receives a target software to be installed in the sensor nodes 100a to 100n from the host computer communication module 350 and forwards it to the sensor node communication module 310.

The host computer communication module 350 is for communicating with any host computer. The host computer communication module 350 receives remote installation/monitor/test instructions and a target software to be installed in the sensor nodes 100a to 100n, from the sensor node integrated development apparatus 500 (See FIG. 1) of the host computer, for example, through the wireless communication. In addition, the host computer communication module 350 wirelessly transmits the state information of the sensor nodes 100a to 100n to the sensor node integrated development apparatus 500 of the host computer in response to the corresponding instructions.

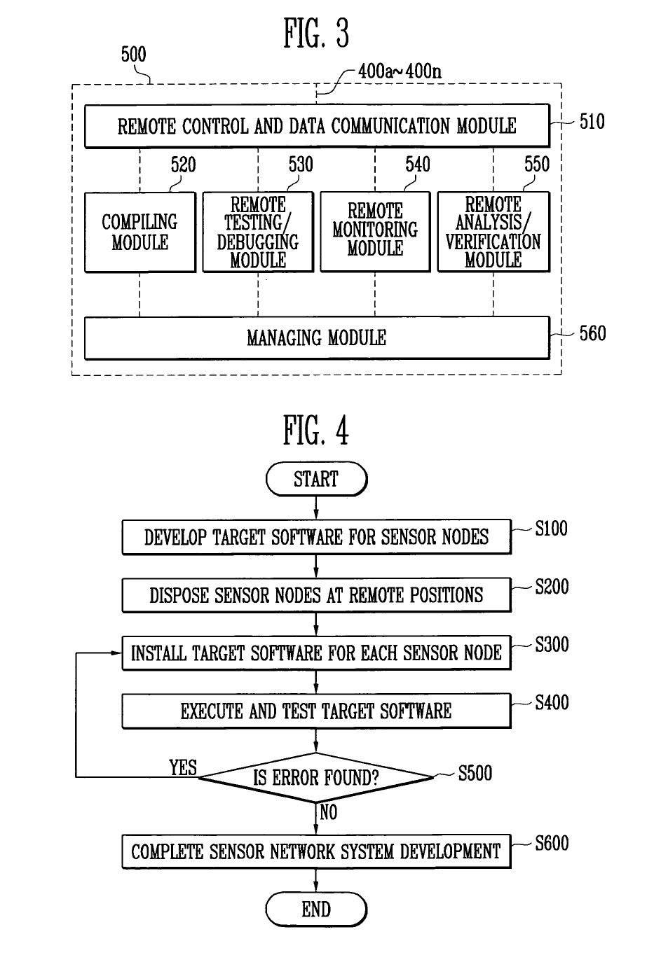

FIG. 3 is a block diagram illustrating a sensor node integrated development apparatus according to an exemplary embodiment of the present invention.

Referring to FIG. 3, a sensor node integrated development apparatus 500 according to an exemplary embodiment of the present invention includes a remote control and data communication module 510, a compiling module 520, a remote testing/debugging module 530, a remote monitoring module 540, a remote analysis/verification module 550, and a managing module 560.

The remote control and data communication module 510 is for remote control and data communication with the sensor node assistant apparatuses 300a to 300n. The remote control and data communication module 510 receives a compiled software image for a sensor node system from the compiling module 520 and wirelessly transmits it, together with an installation instruction, to the sensor node assistant apparatuses 300a to 300n (See FIGS. 1 and 2).

Further, the remote control and data communication module 510 delivers a variety of instructions, which have been generated by the remote testing/debugging module 530, the remote monitoring module 540, and the remote analysis/verification module 550, to the sensor node assistant apparatuses 300a to 300n, for example, through the wireless communication, and wirelessly receives the result of executing the instructions, from the sensor node assistant apparatuses 300a to 300n. It then provides the instruction execution result to the corresponding module that generated the instruction.

Preferably, the remote control and data communication module 510 may have an additional function of serializing and marshaling transmitted and received data since the remote control and data communication module 510 is in simultaneous communication with the plurality of sensor node assistant apparatuses 300a to 300n.

The compiling module 520 is for compiling the target software to be installed in at least one of the sensor nodes 100a to 100n. That is, the compiling module 520 compiles developed target software source codes into software binary codes that are executable in the sensor node network development system.

If the same kind of target software is to be installed in all the sensor nodes 100a to 100n, the compiling module 520 provides one set of binary codes, together with a software installation instruction, to the remote control and data communication module 510. On the other hand, if different kinds of target software are to be installed depending on the type of each of the sensor nodes 100a to 100n, the compiling module 520 generates different sets of target software binary codes and provides the corresponding ones, together with installation information including the kinds of the software to be installed in each sensor node, to the remote control and data communication module 510. Accordingly, a different kind of target software can be installed in each sensor node.

The remote testing/debugging module 530 is for testing and debugging the target software. That is, the remote testing/debugging module 530 simultaneously tests/debugs the target software that have been installed in the several sensor nodes 100a to 100n.

The remote testing/debugging module 530 transmits a variety of testing/debugging instructions and a list of sensor nodes to be tested/debugged, to the remote control and data communication module 510, in order to selectively test/debug all or some of the sensor nodes 100a to 100n. The remote testing/debugging module 530 then receives the testing/debugging result from each of the corresponding sensor nodes.

The remote monitoring module 540 is for remotely monitoring the target software. That is, the remote monitoring module 540 simultaneously monitors the target software that have been installed in the several sensor nodes 100a to 100n.

The remote monitoring module 540 transmits a variety of monitoring instructions and a list of corresponding sensor nodes to be monitored, to the remote control and data communication module 510, in order to selectively monitor all or some of the sensor nodes 100a to 100n. The remote monitoring module 540 then receives the monitoring result from each of the corresponding sensor nodes.

The remote analysis/verification module 550 is for analyzing the target software and verifying system attributes. That is, the remote analysis/verification module 550 analyzes target software that has been installed or will be installed in the several sensor nodes 100a to 100n and verifies the important system attributes.

It is possible to analyze the target software and verify system attributes, not only when the target software has been installed but also when it is not yet installed in the sensor nodes.

The managing module 560 is for managing all modules 510 to 550 in the sensor node integrated development apparatus 500. That is, the managing module 560 manages software development project resources, such as target software source codes, binary codes, compiler information, and installation information, and provides a variety of user interfaces.

The managing module 560 provides a variety of resources requested by a user input and/or the other modules 510 to 550 in the sensor node integrated apparatus 500; tracks resource changes according to the processing results of the other modules; and provides the tracking result to a user.

FIG. 4 is a flowchart illustrating a method for implementing the sensor network development system according to an exemplary embodiment of the present invention.

Referring to FIG. 4, in order to implement the sensor network development system according to an exemplary embodiment of the present invention, target software for identical or different types of sensor nodes 100a to 100n (See FIG. 1) is developed (S100), and the sensor nodes 100a to 100n are disposed at remote positions (S200).

The target software is then installed, executed and tested for each of the sensor nodes 100a to 100n (S300 and S400). The installing, executing and testing of the target software is repeated until there is no error (S500), and the sensor network system development is then completed (S600).

The sensor node assistant apparatus, the sensor node integrated development apparatus, and the sensor network development system using the same according to the present invention as described above have the following advantages. First, while a conventional sensor network system development method requires repeated time-consuming processes of installing target software in individual sensor nodes, disposing the sensor nodes at remote positions, executing and testing the software, and disposing the sensor nodes at adjacent positions until there is no system error, the present invention can significantly shorten development time since the sensor nodes are disposed at remote positions and then only installing and testing of the target software in the sensor nodes is repeated until there is no error.

Second, while a conventional sensor network system development environment allows for installing target software only in one sensor node at a time, the present invention allows the sensor node integrated development apparatus to install target software in a plurality of sensor nodes at one time simply by designating one or more sensor node where target software is to be installed.

Third, it is possible to develop a highly reliable sensor network system since the sensor node assistant apparatus is disposed in addition to target software installed in a sensor node to exactly monitor behavior of the sensor nodes upon execution and testing.

While the sensor node assistant apparatus, the sensor node integrated development apparatus, and the sensor network development system using the same according to the invention have been shown and described with reference to certain exemplary embodiments thereof, it will be understood by those skilled in the art that various changes in form and details may be made therein without departing from the spirit and scope of the invention as defined by the appended claims.

What is claimed is:

1. A sensor node assistant apparatus comprising:
sensor node communication means for performing wired communication with at least one sensor node;
host instruction-processing means for processing an instruction received from a host computer; and
host communication means for performing wireless communication with the host computer.

2. The sensor node assistant apparatus according to claim 1, wherein the sensor node communication means receives target software to be installed in the at least one sensor node from the host instruction-processing means through the host communication means and transmits the target software to each of the at least sensor node through the wired communication, or receives state information from the at least one sensor node and forwards it to the host instruction-processing means.

3. The sensor node assistant apparatus according to claim 1, wherein the host instruction-processing means receives and processes the instruction from the host computer through the host communication means; receives sensor node state information or instruction processing state information from the sensor node communication means and forwards it to the host communication means; and receives target software to be installed in the sensor nodes from the host communication means and forwards it to the sensor node communication means.

4. The sensor node assistant apparatus according to claim 1, wherein the host communication means wirelessly receives remote installation/monitor/test instructions and the target software to be installed in the sensor node from the host computer, and wirelessly transmits the sensor node state information to the host computer in response to the instructions.

5. A sensor node integrated development apparatus comprising:
communication means for remote control and data communication with at least one sensor node;
compiling means for compiling target software to be installed in the at least one sensor node and transmitting the compiled target software to the communication means;
test/debugging means for testing/debugging the target software installed in the at least one sensor node by providing a testing/debugging instruction and a list of sensor nodes to be tested/debugged to the communication means;
monitoring means for monitoring the target software installed in the at least one sensor node by providing a monitoring instruction and a list of sensor nodes to be monitored to the communication means;
analysis/verification means for analyzing the target software and verifying system attributes by providing an analysis/verification instruction and a list of sensor nodes to be analyzed to the communication means; and
managing means for managing the communication means, the compiling means, the test/debugging means, the monitoring means, and the analysis/verification means.

6. The sensor node integrated development apparatus according to claim 5, wherein the communication means receives the compiled target software from the compiling means and wirelessly transmits it together with an installation instruction to the at least one sensor node; receives various instructions from the compiling means, the test/debugging means, the monitoring means, and the analysis/verification mean and wirelessly transmits them to the at least one sensor node; and receives the result of executing each of the various instructions from the at least one sensor node and sends it back to the means that generated the instruction.

7. The sensor node integrated development apparatus according to claim 5, wherein the compiling means compiles source codes of the target software into binary codes executable in the sensor node system.

8. The sensor node integrated development apparatus according to claim 5, wherein, when the same target software is installed in each of the at least one sensor node, the compiling means provides one set of binary codes and an installation instruction to the communication means, and, when different kinds of the target software are installed depending on each type of the at least one sensor node, the compiling means provides different sets of binary codes, together with installation information containing a kind of the target software to be installed in each type of the at lease one sensor node, to the communication means.

9. The sensor node integrated development apparatus according to claim 5, wherein the test/debugging means selectively tests/debugs the at least one sensor node by providing a testing/debugging instruction and a selected list of sensor nodes to be tested/debugged to the communication means and receiving the result of executing the testing/debugging instruction from the communication means.

10. The sensor node integrated development apparatus according to claim 5, wherein the monitoring means selectively monitors the at least one sensor node by providing a monitoring instruction and a selected list of sensor nodes to be monitored and receiving the result of executing the monitoring instruction from the communication means.

11. The sensor node integrated development apparatus according to claim 5, wherein the managing means manages the source codes and binary codes of the target software, compiler information and installation information; provides a user interface; in response to a resource request from any one of the communication means, the compiling means, the test/debugging means, the monitoring means and the analysis/verification means, provides the resource thereto; tracks change of the resource processed by the any one of them and provides it to a user.

12. A sensor network development system comprising:
a sensor node assistant apparatus disposed in at least one sensor node and communicating with a host computer, processing instructions generated from the host computer, and communicating with the at least one sensor node; and
a sensor node integrated development apparatus disposed in the host computer and communicating with the sensor node assistant apparatus to control the at least one sensor node.

13. The sensor network development system according to claim 12, wherein the communication between the sensor node assistant apparatus and the sensor nodes is performed over a wire and the communication between the sensor node assistant apparatus and the sensor node integrated development apparatus is performed wirelessly.
